(19) United States
(12) Patent Application Publication
(10) Pub. No.: US 2018/0195627 A1
(43) Pub. Date: Jul. 12, 2018

(54) COMBINATION VALVE AND BIDIRECTIONAL FLOW CONTROL VALVE USING THE SAME

(71) Applicant: KYB Corporation, Tokyo (JP)

(72) Inventor: Toru TAKEUCHI, Kanagawa (JP)

(73) Assignee: KYB Corporation, Tokyo (JP)

(21) Appl. No.: 15/742,572

(22) PCT Filed: Jul. 8, 2016
(86) PCT No.: PCT/JP2016/070323

§ 371 Date: Jan. 8, 2018

(30) Foreign Application Priority Data
Jul. 31, 2015 (JP) 2015-152406

(51) Int. Cl. F16K 11/10; F16K 11/24

(52) U.S. Cl. CPC F16K 11/105; F16K 11/24

(57) ABSTRACT

A combination valve built in a main valve of a solenoid valve includes: a first communication passage having a first port and a second port; a second communication passage branching from the first communication passage and having a third port; a first valve body provided in the first communication passage and configured to permit only the flow of working oil from the first port to the third port; and a second valve body provided in the first communication passage and configured to permit only the flow of working oil from the first port to the second port. The first valve body is located upstream relative to the second valve body.

### TECHNICAL FIELD

The present invention relates to a combination valve and a bidirectional flow control valve using the same.

### BACKGROUND ART

Hydraulically operated construction machines and industrial machines use a bidirectional flow control valve that controls a flow rate of working oil flowing bidirectionally between two ports in accordance with an electromagnetic force.

JP 2002-106743A describes a bidirectional flow control valve including a main valve that has two built-in valve bodies and a control pressure chamber that biases the main valve in a direction of closing the main valve. A flow rate of working oil flowing between two ports is controlled by displacement of the main valve caused by communication between the control pressure chamber and a low-pressure port via one of the two valve bodies built in the main valve.

### SUMMARY OF INVENTION

In the bidirectional flow control valve disclosed in JP 2002-106743A, the two valve bodies built in the main valve are separately disposed in a passage extending in an axial direction of the main valve and a passage extending in a radial direction of the main valve, respectively. Therefore, in this bidirectional flow control valve, the main valve has a large outer diameter, thereby increasing the size of the bidirectional flow control valve itself. This could possibly deteriorate the attachability of the bidirectional flow control valve.

One possible way to prevent an increase in the size of the bidirectional flow control valve is to reduce the size of the valve body disposed in the passage extending in the radial direction. However, a reduction in the size of the valve body leads to a reduction in the permitted abrasion limit. This could possibly make it difficult to maintain the sealing performance between the valve body and a valve seat over a long period of time.

The present invention aims to downsize a combination valve including two valve bodies and a bidirectional flow control valve using the same.

According to one aspect of the present invention, a combination valve includes: a first flow passage having a first port and a second port located at an upstream side and a downstream side of the first flow passage, respectively; a second flow passage branching from the first flow passage and having a third port; a first valve body provided in the first flow passage and configured to allow only a flow of a working fluid from the first port to the third port; a through hole provided in the first valve body and forming a part of the first flow passage; and a second valve body provided in the first flow passage and configured to allow only the flow of the working fluid from the first port to the second port via the through hole. The first valve body is located upstream relative to the second valve body.

### BRIEF DESCRIPTION OF DRAWINGS

FIG. 1 is a cross-sectional view of a solenoid valve according to an embodiment of the present invention.

FIG. 2 is an enlarged view of a combination valve shown in FIG. 1.

FIG. 3 is a cross-sectional view taken along the line III-III in FIG. 2.

FIG. 4 shows a modification example of the combination valve.

FIG. 5 shows a hydraulic circuit for the combination valve.

### DESCRIPTION OF EMBODIMENTS

The following describes an embodiment of the present invention with reference to the attached drawings.

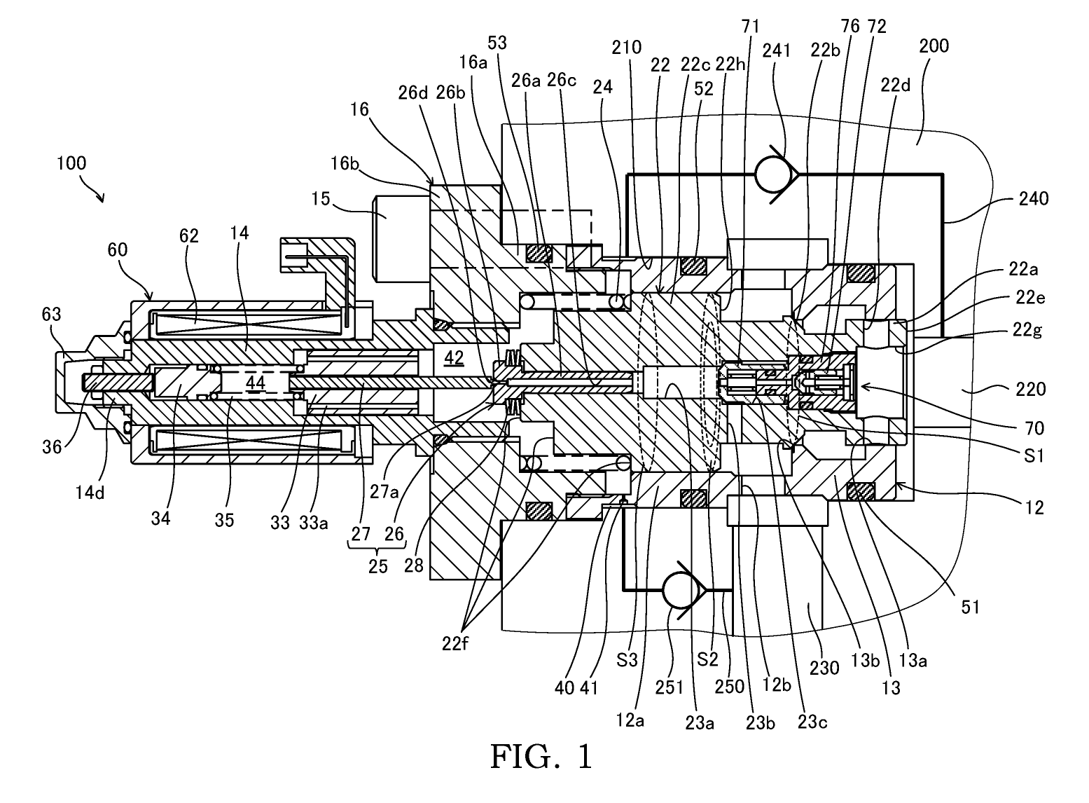

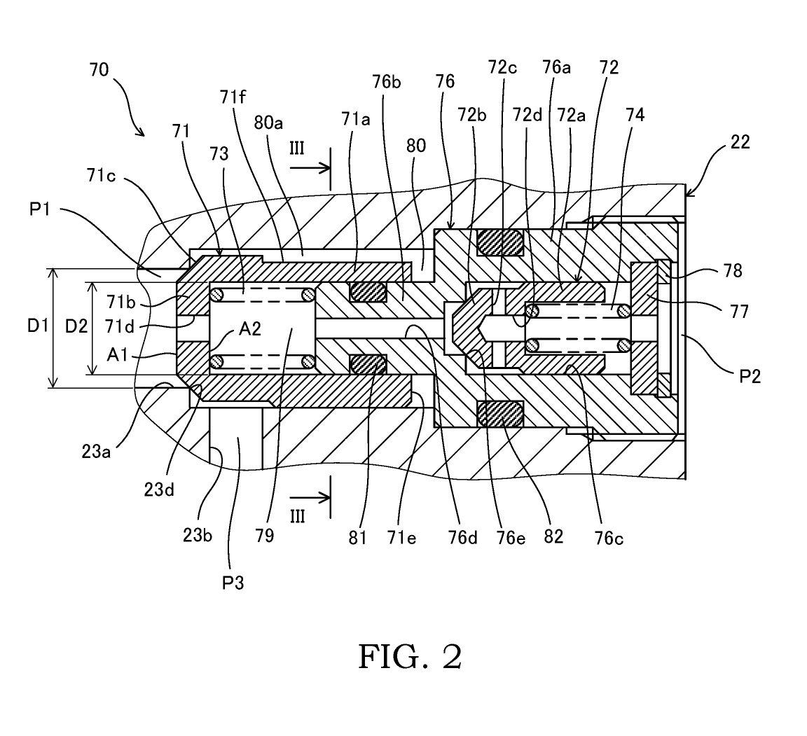

A combination valve 70 according to the embodiment of the present invention, as well as a solenoid valve 100 using the same, will now be described with reference to FIGS. 1 and 2.

The solenoid valve 100, shown in FIG. 1, is provided in construction machines, industrial machines, and so forth to control a flow rate of a working fluid supplied from a non-illustrated fluid pressure source to an actuator (load), and a flow rate of a working fluid discharged from the actuator to, for example, a tank. This solenoid valve 100 is a bidirectional flow control valve that can control both a flow rate of a working fluid flowing from a main port 220 to a sub port 230, and a flow rate of a working fluid flowing from the sub port 230 to the main port 220.

The solenoid valve 100 is fixedly inserted in a non-penetrating insertion hole 210 provided in a valve block 200. The valve block 200 has the main port 220 and the sub port 230. One end of the main port 220 opens to a bottom surface of the insertion hole 210. The other end of the main port 220 opens to an outer surface of the valve block 200, and is selectively connected, via a non-illustrated switching valve, to the fluid pressure source or the tank via, for example, a non-illustrated pipe. One end of the sub port 230 opens to a side surface of the insertion hole 210. The other end of the sub port 230 opens to an outer surface of the valve block 200, and is connected to the actuator via, for example, a non-illustrated pipe.

In the solenoid valve 100, working oil is used as the working fluid. When the main port 220 is connected to the fluid pressure source, working oil flows from the main port 220 to the sub port 230. When the main port 220 is connected to the tank, working oil flows from the sub port 230 to the main port 220. The working fluid is not limited to working oil, and may be another incompressible fluid or compressible fluid.

The solenoid valve 100 includes a main valve 22, a hollow cylindrical sleeve 12, and a solenoid unit 60. The main valve 22 controls a flow rate of working oil supplied to the actuator via the main port 220 and the sub port 230 or working oil discharged from the actuator. The sleeve 12, in which the main valve 22 is slidably inserted, is fixed inside the insertion hole 210. The solenoid unit 60 displaces the main valve 22 in an axial direction.

The sleeve 12 includes a slide support 12a and a seat 13. An outer circumferential surface of the main valve 22 is slidably supported by the slide support 12a. The seat 13 allows the main valve 22 to be seated thereon.

Two seat portions, namely, a first seat portion 13a that forms a circular hole and a second seat portion 13b that forms a circular truncated cone, are arranged on an inner circumference of the seat 13 in this order, with the first seat portion 13a being closer to the main port 220 than the second seat portion 13b is. A central axis of the first seat portion 13a and a central axis of the second seat portion 13b coincide with a central axis of the sleeve 12.

In the sleeve 12, a plurality of communication holes 12b that enable communication between a space inside the sleeve 12 and the sub port 230 are provided at circumferential intervals between the second seat portion 13b and the slide support 12a.

An O-ring 51 and an O-ring 52 are mounted on an outer circumference of the seat 13 and an outer circumference of the slide support 12a, respectively, with the communication holes 12b interposed therebetween. The site of connection between the communication holes 12b and the sub port 230 is sealed by the two O-rings 51, 52 that are compressed between the sleeve 12 and the insertion hole 210. Especially, the O-ring 51 mounted on the outer circumference of the seat 13 prevents the main port 220 and the sub port 230 from communicating with each other via a gap between the sleeve 12 and the insertion hole 210.

The main valve 22 is a columnar member that is disposed inside the sleeve 12 in such a manner that one end surface 22e is located near the seat 13, and a slide portion 22c is slidably supported by the slide support 12a.

The main valve 22 has a columnar spool valve 22a that is located near one end surface 22e and slidably inserted in the first seat portion 13a. The main valve 22 also has a poppet valve 22b that is located between the spool valve 22a and the slide portion 22c, can be seated on the second seat portion 13b, and forms a circular truncated cone. The main valve 22 further has a step portion 22h that is located between the poppet valve 22b and the slide portion 22c and has a surface perpendicular to the axial direction of the main valve 22. The pressure in the sub port 230 acts on the step portion 22h via the communication holes 12b.

A recess 22g that communicates with the main port 220 is provided on one end surface 22e of the main valve 22 so as to be coaxial with the spool valve 22a. A plurality of through holes 22d are provided at circumferential intervals in the spool valve 22a. One end of each through hole 22d opens to a surface that slides on the first seat portion 13a. The other end of each through hole 22d opens to an inner circumferential surface of the recess 22g.

Each through hole 22d, which is closed by the first seat portion 13a, is gradually opened as the spool valve 22a moves in a direction of separating the poppet valve 22b and the second seat portion 13b from each other. That is, an exposed opening area of each through hole 22d is created by separation from the first seat portion 13a, and changes in accordance with an amount of movement of the spool valve 22a. Such a change in the opening area of each through hole 22d enables control of a flow rate of working oil flowing from the main port 220 to the sub port 230, or a flow rate of working oil flowing from the sub port 230 to the main port 220.

Each through hole 22d is arranged in such a manner that it is not completely closed by the first seat portion 13a even when the poppet valve 22b is in contact with the second seat portion 13b. That is, the opening area of each through hole 22d has the smallest value at a valve-closing position where the poppet valve 22b is in contact with the second seat portion 13b, and gradually increases as the poppet valve 22b is displaced in a direction of opening the poppet valve 22b.

Each through hole 22d may be arranged in such a manner that it is closed by the first seat portion 13a until the poppet valve 22b moves away from the second seat portion 13b to a certain extent. In this case, a flow rate of working oil can be set to almost zero until the main valve 22 is displaced to a certain extent.

The other end surface 22f of the main valve 22 faces a pilot pressure chamber 42 defined by the main valve 22, the sleeve 12, and the solenoid unit 60.

A main lead-in passage 240 connecting the main port 220 and the pilot pressure chamber 42 together, as well as a sub lead-in passage 250 connecting the sub port 230 and the pilot pressure chamber 42 together, is provided in the valve block 200. The main lead-in passage 240 and the sub lead-in passage 250 communicate with the pilot pressure chamber 42 via an annular space 40 provided between the sleeve 12 and the valve block 200, and via a lead-in hole 41 that is provided in the sleeve 12 and functions as an orifice.

A main lead-in check valve 241 that allows only the flow from the main port 220 to the pilot pressure chamber 42 is provided in the main lead-in passage 240. A sub lead-in check valve 251 that allows only the flow from the sub port 230 to the pilot pressure chamber 42 is provided in the sub lead-in passage 250.

Therefore, when the pressure in the main port 220 is higher than the pressure in the sub port 230, working oil in the main port 220 is directed to the pilot pressure chamber 42 via the main lead-in passage 240, the main lead-in check valve 241, the annular space 40, and the lead-in hole 41. At this time, the sub lead-in check valve 251 blocks the flow from the pilot pressure chamber 42 to the sub port 230. On the other hand, when the pressure in the sub port 230 is higher than the pressure in the main port 220, working oil in the sub port 230 is directed to the pilot pressure chamber 42 via the sub lead-in passage 250, the sub lead-in check valve 251, the annular space 40, and the lead-in hole 41. At this time, the main lead-in check valve 241 blocks the flow from the pilot pressure chamber 42 to the main port 220.

Inside the pilot pressure chamber 42, a main return spring 24 is disposed in a compressed state between the main valve 22 and the solenoid unit 60.

A biasing force of the main return spring 24 acts in a direction of closing the main valve 22. The pressure in the main port 220 acts on a first valve-opening pressure receiving surface S1 that is equivalent to a cross-section of the second seat portion 13b of the main valve 22, thereby acting in a direction of opening the main valve 22. The pressure in the sub port 230 acts on a second valve-opening pressure receiving surface S2 that is equivalent to a cross-section of the step portion 22h of the main valve 22, thereby acting in the direction of opening the main valve 22. The pressure inside the pilot pressure chamber 42 acts on a valve-closing pressure receiving surface S3 that is equivalent to a cross-section of the tube portion 22c, thereby acting in the direction of closing the main valve 22.

Therefore, the main valve 22 is displaced in the direction of opening the main valve 22 when a net force obtained from a thrust attributed to the pressure in the main port 220 acting on the first valve-opening pressure receiving surface S1 and from a thrust attributed to the pressure in the sub port 230 acting on the second valve-opening pressure receiving surface S2 exceeds a net force obtained from a thrust attributed to the pressure inside the pilot pressure chamber 42 acting on the valve-closing pressure receiving surface A2 and from the biasing force of the main return spring 24. On the other hand, the main valve 22 is displaced in the direction of closing the main valve 22 when the former falls below the latter.

The main valve 22 further has a first communication passage 23a serving as a first flow passage, and a second communication passage 23b serving as a second flow passage. The first communication passage 23a connects the pilot pressure chamber 42 and the main port 220 together. The second communication passage 23b branches from the first communication passage 23a, and connects the first communication passage 23a and the sub port 230 together.

The first communication passage 23a is a through hole that is provided in the main valve 22 in such a manner that a central axis of the first communication passage 23a coincides with a central axis of the main valve 22. The first communication passage 23a opens to the other end surface 22f at one end, and opens to the recess 22g at the other end. Therefore, the first communication passage 23a is processed along with processing of the recess 22g of the main valve 22 and the like. The second communication passage 23b extends in a radial direction of the main valve 22. The second communication passage 23b communicates with the first communication passage 23a at one end, and opens to the outer circumferential surface of the main valve 22 at the other end. The other end of the second communication passage 23b is arranged in such a manner that it always communicates with the communication holes 12b in the range of displacement of the main valve 22 in the axial direction. The later-described combination valve 70 is provided in the first communication passage 23a.

The main valve 22 also includes a pilot pressure control valve 25 that controls the pressure inside the pilot pressure chamber 42 by adjusting the state of communication between the pilot pressure chamber 42 and the first communication passage 23a.

The pilot pressure control valve 25 includes a hollow cylindrical pressure compensation sleeve 26 provided with a sub seat 26d, and a columnar sub valve 27. One end of the sub valve 27 has a sub poppet valve 27a that can be seated on the sub seat 26d.

The pressure compensation sleeve 26 has a slide portion 26a that is slidably inserted in the first communication passage 23a, a flange 26b that faces the pilot pressure chamber 42 and is larger in outer diameter than the slide portion 26a, and a through hole 26c that penetrates the flange 26b and the slide portion 26a in the axial direction. The sub seat 26d is provided at an open end of the through hole 26c that opens to the flange 26b. Therefore, the first communication passage 23a and the pilot pressure chamber 42 communicate with each other via the sub seat 26d and the through hole 26c.

A pressure compensation spring 28 composed of a plurality of disc springs is interposed between the flange 26b and the other end surface 22f of the main valve 22. The pressure compensation sleeve 26 is biased by the pressure compensation spring 28 in a direction away from the main valve 22.

When the sub poppet valve 27a is separated from the sub seat 26d, a gap is created between the sub poppet valve 27a and the sub seat 26d, and working oil inside the pilot pressure chamber 42 is directed from this gap to the first communication passage 23a via the through hole 26c and discharged to the main port 220 or the sub port 230 via the combination valve 70. Although working oil is directed to the pilot pressure chamber 42 via the main lead-in passage 240 or the sub lead-in passage 250, as the lead-in hole 41 limits the inflow of working oil to the pilot pressure chamber 42, the pressure inside the pilot pressure chamber 42 decreases in consequence. The pressure inside the pilot pressure chamber 42 is thus controlled by the pilot pressure control valve 25.

The size of the gap between the sub poppet valve 27a and the sub seat 26d is adjusted by changing a position of the sub valve 27 in the axial direction relative to the pressure compensation sleeve 26. As the solenoid unit 60 controls the position of the sub valve 27 in the axial direction, the solenoid unit 60 controls the size of this gap.

The solenoid unit 60 includes a coil 62 that drives the sub valve 27 when current is supplied thereto, a bottomed cylindrical solenoid tube 14, a plunger 33 that is slidably housed in the solenoid tube 14 and joined to the sub valve 27, and a joint member 16 that joins the solenoid tube 14 and the sleeve 12 together. The coil 62 is provided around an outer circumference of the solenoid tube 14.

The cylindrical plunger 33, a columnar retainer 34, and a sub return spring 35 are provided inside the solenoid tube 14. The sub valve 27 is fixed to a shaft center of the plunger 33. The retainer 34 is movable in the axial direction. The sub return spring 35 is interposed in a compressed state between the plunger 33 and the retainer 34. The sub return spring 35 biases the plunger 33 in a direction of seating the sub poppet valve 27a, which is provided on a tip of the sub valve 27, on the sub seat 26d.

The plunger 33 has a plurality of through holes 33a that penetrate the plunger 33 in the axial direction. A spring chamber 44, in which the sub return spring 35 is disposed, communicates with the pilot pressure chamber 42 via the through holes 33a. Therefore, the pressure inside the spring chamber 44 is equal to the pressure inside the pilot pressure chamber 42, and a biasing force of the sub return spring 35 and the pressure inside the spring chamber 44 act in a direction of pressing the sub poppet valve 27a toward the sub seat 26d.

An adjustment screw 36 is screwed to an end portion 14d of the solenoid tube 14 so as to penetrate the end portion 14d in the axial direction. One end of the adjustment screw 36 is in contact with the retainer 34 disposed inside the spring chamber 44. Rotation of the adjustment screw 36 changes a position of the retainer 34 in the axial direction, thereby changing the biasing force of the sub return spring 35. Thus, an initial load that is generated by the sub return spring 35 and acts on the plunger 33 can be changed by rotating the adjustment screw 36. The other end of the adjustment screw 36 projects from the solenoid tube 14, and is covered by a cover 63 attached to the solenoid tube 14.

The joint member 16 includes an insertion portion 16a that is inserted in the insertion hole 210 of the valve block 200, and a flange 16b for fixing the solenoid valve 100 to the valve block 200. The solenoid tube 14 is screwed to an inner circumferential surface of the flange 16b, and the sleeve 12 is screwed to the insertion portion 16a. As a result, the joint member 16 joins the sleeve 12 and the solenoid tube 14 together.

An O-ring 53 serving as a seal member is mounted on an outer circumference of the insertion portion 16a. The O-ring 53, which is compressed between the joint member 16 and the insertion hole 210, blocks communication between the interior of the insertion hole 210 and the outside. This can not only prevent working oil inside the insertion hole 210 from leaking to the outside, but also prevent external water, dust, and so forth from entering the interior of the insertion hole 210.

The flange 16b has a plurality of non-illustrated bolt holes through which bolts 15 are inserted. The flange 16b is fastened to the valve block 200 via the bolts 15. The solenoid valve 100 is fixed to the valve block 200 due to the joint member 16 being fastened to the valve block 200.

A description is now given of the combination valve 70 provided in the first communication passage 23a of the main valve 22 with reference to FIGS. 1 to 3.

As shown in FIG. 2, the combination valve 70 has a first port P1, a second port P2, and a third port P3. The first port P1 is located at the upstream side of the first communication passage 23a, and connected to the pilot pressure chamber 42 via the pilot pressure control valve 25. The second port P2 is located at the downstream side of the first communication passage 23a, and communicates with the main port 220. The third port P3 is located in the second communication passage 23b, and communicates with the sub port 230.

The combination valve 70 also has a first valve body 71 that allows only the flow of working oil from the first port P1 to the third port P3, a second valve body 72 that allows only the flow of working oil from the first port P1 to the second port P2, and a support member 76 by which the first valve body 71 is slidably supported and in which the second valve body 72 is slidably housed. As shown in FIG. 2, the first valve body 71 and the second valve body 72 are arranged in series so as to line up along the first communication passage 23a that has a linear shape. That is, the first valve body 71, which restricts a flowing direction of working oil that flows through the second communication passage 23b extending in the radial direction of the main valve 22, is not disposed in the second communication passage 23b, but in the first communication passage 23a extending in the axial direction of the main valve 22 together with the second valve body 72. Note that the first communication passage 23a is not limited to having a linear shape, and may have a bent portion. In this case also, the first valve body 71 and the second valve body 72 are arranged in series along the first communication passage 23a.

The first valve body 71 is a bottomed cylindrical poppet valve, and includes a hollow cylindrical portion 71a extending along an axial direction of the first communication passage 23a, and an top end portion 71b provided with a valve portion 71c that can be seated on a seat 23d. The seat 23d is provided in the first communication passage 23a, and forms a circular truncated cone. The top end portion 71b has a through hole 71d that penetrates the top end portion 71b in the axial direction of the first communication passage 23a.

Compared with a portion where the second communication passage 23b opens to the first communication passage 23a, the seat 23d is close to the pilot pressure chamber 42. Therefore, when the valve portion 71c is seated on the seat 23d, communication between the first port P1 and the third port P3 is blocked. The seat 23d may be provided directly in the first communication passage 23a. Alternatively, a member provided with the seat 23d may be fixedly inserted in the first communication passage 23a.

The support member 76 has a main body 76a, a support portion 76b, a accommodation hole 76c, and an axially penetrating communication hole 76d. The main body 76a is fixed inside the first communication passage 23a. The support portion 76b projects from the main body 76a toward the first port P1, and is inserted in the hollow cylindrical portion 71a of the first valve body 71. The accommodation hole 76c is provided inside the main body 76a, and allows the second valve body 72 to be housed therein. The first valve body 71 and the second valve body 72 are supported by the support member 76 in such a manner that they are displaced along the first communication passage 23a. The support member 76 is fixed inside the first communication passage 23a due to an outer circumference of the main body 76a being screwed to the first communication passage 23a.

The support portion 76b defines a first pressure chamber 79 inside the first valve body 71. The pressure in the first port P1 is directed to the first pressure chamber 79 via the through hole 71d. A first spring 73 serving as a first biasing member that biases the first valve body 71 in a direction of closing the first valve body 71 is installed inside the first pressure chamber 79.

It is preferable that a diameter D2 of the first pressure chamber 79 be large so that the first spring 73 is easily housed in the first pressure chamber 79. However, because the pressure in the first port P1 is directed to the first pressure chamber 79 via the through hole 71d, if the diameter D2 of the first pressure chamber 79 is larger than a diameter D1 of the seat 23d, a force acting in the direction of closing the first valve body 71 will be relatively large, and hence the first valve body 71 cannot be opened.

For this reason, the diameter D2 of the first pressure chamber 79 is set to be smaller than the diameter D1 of the seat 23d. In other words, the diameter D2 of the first pressure chamber 79 is set so that, when the valve portion 71c of the first valve body 71 is seated on the seat 23d, a first pressure receiving surface Al of the top end portion 71b that receives the pressure in the first port P1 acting in a direction of opening the first valve body 71 is larger in area than a second pressure receiving surface A2 of the top end portion 71b that receives the pressure in the first pressure chamber 79.

An annular second pressure chamber 80 is provided between an end surface 71e of the hollow cylindrical portion 71a and the main body 76a of the support member 76 that axially opposes the end surface 71e. The pressure in the third port P3 is directed to the second pressure chamber 80. As shown in FIG. 2, an inner diameter of the second pressure chamber 80 is equal to the diameter D2 of the first pressure chamber 79, and smaller than the diameter D1 of the seat 23d. Therefore, the pressure of working oil directed to the interior of the second pressure chamber 80 acts in the direction of closing the first valve body 71.

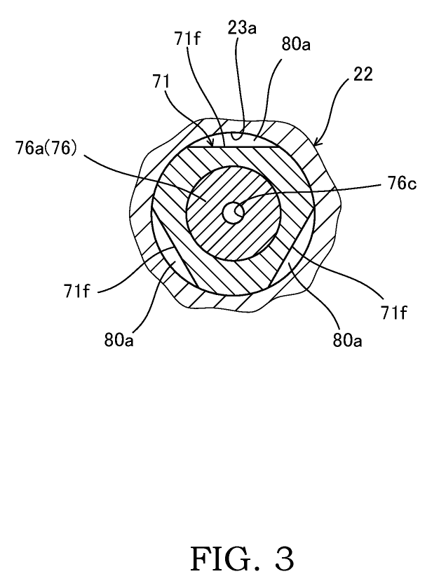

As shown in FIG. 3, a plurality of cutouts 71f are provided at circumferential intervals on an outer circumferential surface of the hollow cylindrical portion 71a. The cutouts 71f and the first communication passage 23a define communication passages 80a that direct the pressure in the third port P3 to the second pressure chamber 80. The cutouts 71f are not limited to being configured in the foregoing manner, and may be provided by cutting out an inner wall surface of the first communication passage 23a. Furthermore, each communication passage 80a is not limited to having a shape of a cutout, and may have any shape as long as it can direct the pressure. For example, the communication passages 80a may be internal holes that are provided in the hollow cylindrical portion 71a or the main valve 22 to enable communication between the second pressure chamber 80 and the third port P3. The number of the communication passages 80a is not limited to two or more, and may be only one. When the plurality of cutouts 71f are provided at an equal circumferential interval, an area of contact between the inner wall surface of the first communication passage 23a and the hollow cylindrical portion 71a is reduced. This can reduce sliding resistance.

An O-ring 81 serving as a seal member compressed between the support portion 76b of the support member 76 and the hollow cylindrical portion 71a is mounted on an outer circumference of the support portion 76b. This prevents the first pressure chamber 79 and the second pressure chamber 80 from communicating with each other via a gap between the support portion 76b and the hollow cylindrical portion 71a. An O-ring 82 compressed between the main body 76a of the support member 76 and the first communication passage 23a is mounted on the outer circumference of the main body 76a. This prevents the second pressure chamber 80 and the second port P2 from communicating with each other via a gap between the main body 76a and the first communication passage 23a. Backup rings may be disposed adjacent to the O-rings 81, 82 to restrain the O-rings 81, 82 from sticking out. Members for blocking communication are not limited to the O-rings 81, 82, and may be any seal members that can achieve hermetical seal, such as seal rings.

The first valve body 71 moves away from the seat 23d by compressing the first spring 73 when the pressure in the first port P1 is higher than the pressure in the third port P3 by a difference equal to or larger than a predetermined value. Specifically, the valve portion 71c is separated from the seat 23d when a force acting in the direction of opening the first valve body 71 due to a pressure difference between the pressure in the first port P1 and the pressure in the third port P3 exceeds a biasing force of the first spring 73. Consequently, working oil is directed from the first port P1 to the third port P3 via a gap between the valve portion 71c and the seat 23d.

On the other hand, when the pressure in the third port P3 is equal to or higher than the pressure in the first port P1, the biasing force of the first spring 73 and the pressure inside the second pressure chamber 80 act in the direction of closing the first valve body 71. Consequently, the first valve body 71 is seated on the seat 23d. Thus, the first valve body 71 allows only the flow of working oil from the first port P1 to the third port P3, and prevents working oil from flowing in reverse.

The second valve body 72 is a bottomed cylindrical poppet valve, and has a hollow cylindrical portion 72a that is slidably supported inside the accommodation hole 76c, a valve portion 72b that can be seated on a seat 76e, and radial communication holes 72c. The seat 76e is provided in the accommodation hole 76c, and forms a circular truncated cone. The radial communication holes 72c are provided between the hollow cylindrical portion 72a and the valve portion 72b, and radially penetrate the second valve body 72.

An annular spring sheet 77 and a retaining ring 78 are disposed near an open end of the accommodation hole 76c of the support member 76 that houses the second valve body 72. The retaining ring 78 is intended to fix the spring sheet 77 inside the accommodation hole 76c. A second spring 74 serving as a second biasing member is interposed in a compressed state between the second valve body 72 and the spring sheet 77. The second spring 74 biases the second valve body 72 in a direction of closing the second valve body 72.

The second valve body 72 moves away from the seat 76e by compressing the second spring 74 when the pressure in the first port P1 is higher than the pressure in the second port P2 by a difference equal to or larger than a predetermined value. Specifically, the valve portion 72b is separated from the seat 76e when a force acting in a direction of opening the second valve body 72 due to a pressure difference between the pressure in the first port P1 and the pressure in the second port P2 exceeds a biasing force of the second spring 74. Consequently, working oil is directed from the first port P1 to the second port P2 via the through hole 71d, the communication hole 76d, the radial communication holes 72c, and a hollow portion 72d inside the second valve body 72.

If a diameter of the through hole 71d is smaller than a diameter of the communication hole 76d, the through hole 71d functions as a throttle, the pressure acting on the second valve body 72 decreases, and the speed of opening/closing the second valve body 72 drops. This could possibly lower responsiveness. For this reason, the diameter of the through hole 71d is set to be larger than the diameter of the communication hole 76d.

Furthermore, if the diameter of the through hole 71d is small, the through hole 71d functions as a throttle, and the pressure in the first pressure chamber 79 decreases. This could possibly open the first valve body 71 when a pressure difference between the first port P1 and the third port P3 is smaller than a set value. To prevent such opening of the first valve body 71, it is necessary to increase the biasing force of the first spring 73. However, if the biasing force of the first spring 73 is increased, it will be difficult to open the first valve body 71, and responsiveness is lowered. In view of this, it is preferable to make the diameter of the through hole 71d as large as possible. With such a through hole 71d having a large diameter, the biasing force of the first spring 73 can be made small. This can increase a degree of freedom in designing of the first spring 73, and improve the responsiveness of the first valve body 71. Note that the diameter of the through hole 71d may be set to be smaller than the diameter of the communication hole 76d as long as each of the valve bodies 71, 72 satisfies, for example, the required responsiveness.

On the other hand, when the pressure in the second port P2 is equal to or higher than the pressure in the first port P1, the biasing force of the second spring 74 and the pressure in the second pot P2 act in the direction of closing the second valve body 72. Consequently, the second valve body 72 is seated on the seat 76e. Thus, the second valve body 72 allows only the flow of working oil from the first port P1 to the second port P2, and prevents working oil from flowing in reverse.

The operations of the solenoid valve 100 will now be described.

First, a description will be given of a case in which a flow rate of working oil flowing from the main port 220 to the sub port 230 is controlled while the main port 220 is connected to the fluid pressure source.

When current is not supplied to the coil 62, the plunger 33 is pressed by the biasing force of the sub return spring 35, the sub poppet valve 27a of the sub valve 27 is seated on the sub seat 26d, and the pilot pressure chamber 42 is in a closed state. Therefore, working oil in the main port 220 is directed to the interior of the pilot pressure chamber 42 via the main lead-in passage 240, the annular space 40, and the lead-in hole 41, and the pressure inside the pilot pressure chamber 42 becomes equal to the pressure in the main port 220. That is, the pressure equal to the pressure in the main port 220 acts on the valve-closing pressure receiving surface S3.

Here, the valve-closing pressure receiving surface S3 on which the pressure inside the pilot pressure chamber 42 acts is larger in area than the first valve-opening pressure receiving surface S1 on which the pressure in the main port 220 acts. Furthermore, the pressure in the sub port 230 is sufficiently lower than the pressure in the main port 220. Therefore, a net force obtained from a thrust attributed to the pressure inside the pilot pressure chamber 42 acting on the valve-closing pressure receiving surface S3 and from the biasing force of the main return spring 24 exceeds the net force obtained from the thrust attributed to the pressure in the main port 220 acting on the first valve-opening pressure receiving surface S1 and from the thrust attributed to the pressure in the sub port 230 acting on the second valve-opening pressure receiving surface S2. Consequently, the main valve 22 is pushed in a direction of closing the seat 13. Thus, when current is not flowing through the coil 62, the flow of working oil from the main port 220 to the sub port 230 is blocked.

On the other hand, when current is supplied to the coil 62, a thrust generated by the solenoid unit 60 causes the plunger 33 to overcome the biasing force of the sub return spring 35, and the plunger 33 is attracted toward the coil 62. As the sub valve 27 is displaced together with the plunger 33, the sub poppet valve 27a is separated from the sub seat 26d, and a gap is created between the sub poppet valve 27a and the sub seat 26d. Working oil inside the pilot pressure chamber 42 is directed to the first communication passage 23a, that is, the first port P1 of the combination valve 70, via this gap.

As the second port P2 of the combination valve 70 faces the main port 220, the pressure in the second port P2 is the same as the pressure in the main port 220. That is, the pressure in the second port P2 is substantially the same as the pressure in the first port P1. Therefore, the second valve body 72 blocks the flow of working oil from the first port P1 to the second port P2 as described above.

On the other hand, as the third port P3 of the combination valve 70 faces the sub port 230, the pressure in the third port P3 is sufficiently lower than the pressure in the first port P1, that is, the pressure in the main port 220. Therefore, the first valve body 71 allows the flow of working oil from the first port P1 to the third port P3 as described above. As a result, working oil inside the pilot pressure chamber 42 is discharged to the sub port 230 via the first communication passage 23a, the second communication passage 23b, and the communication holes 12b.

As the lead-in hole 41 limits the inflow of working oil from the main port 220 to the pilot pressure chamber 42, the pressure inside the pilot pressure chamber 42 decreases due to communication between the pilot pressure chamber 42 and the sub port 230. The main valve 22 is displaced in a direction of opening the seat 13 until the net force obtained from the thrust attributed to the pressure inside the pilot pressure chamber 42 acting on the valve-closing pressure receiving surface S3 and from the biasing force of the main return spring 24 comes into balance with the net force obtained from the thrust attributed to the pressure in the main port 220 acting on the first valve-opening pressure receiving surface S1 and from the thrust attributed to the pressure in the sub port 230 acting on the second valve-opening pressure receiving surface S2. As a result, working oil flows from the main port 220 to the sub port 230 via a gap between the through holes 22d and the first seat portion 13a, a gap between the poppet valve 22b and the second seat portion 13b, and the communication holes 12b.

An increase in the current supplied to the coil 62 causes the sub poppet valve 27a to be further separated from the sub seat 26d. As a result, an amount of working oil discharged from the pilot pressure chamber 42 to the sub port 230 increases, and the pressure inside the pilot pressure chamber 42 further decreases. Along with such a decrease in the pressure inside the pilot pressure chamber 42, the main valve 22 moves further in the direction of opening the seat 13. This leads to an increase in the exposed opening areas of the through holes 22d of the spool valve 22a created by separation from the first seat portion 13a. Consequently, a flow rate of working oil flowing from the main port 220 to the sub port 230 increases.

As described above, a flow rate of working oil flowing from the main port 220 to the sub port 230 is controlled by controlling an amount of displacement of the main valve 22 through an operation of increasing/decreasing current supplied to the coil 62.

When current is stopped from flowing through the coil 62, the thrust that attracts the plunger 33 is dissolved, and thus the plunger 33 is pressed by the biasing force of the sub return spring 35. Then, the sub poppet valve 27a of the sub valve 27 is seated on the sub seat 26d. As a result, working oil in the main port 220 is directed to the interior of the pilot pressure chamber 42 via the lead-in hole 41, and the pressure inside the pilot pressure chamber 42 increases to the point where it is equal to the pressure in the main port 220.

Once the pressure inside the pilot pressure chamber 42 has become equal to the pressure in the main port 220, the net force obtained from the thrust attributed to the pressure in the main port 220 acting on the first valve-opening pressure receiving surface S1 and from the thrust attributed to the pressure in the sub port 230 acting on the second valve-opening pressure receiving surface S2 falls below the net forth obtained from the thrust attributed to the pressure inside the pilot pressure chamber 42 acting on the valve-closing pressure receiving surface S3 and from the biasing force of the main return spring 24, as described above. Thus, the main valve 22 is pushed in the direction of closing the seat 13. As a result, the main valve 22 is displaced in the direction of closing the seat 13, and the flow of working oil from the main port 220 to the sub port 230 is blocked.

Next, a description will be given of a case in which a flow rate of working oil flowing from the sub port 230 and the main port 220 is controlled while the main port 220 is connected to the tank.

When current is not supplied to the coil 62, the plunger 33 is pressed by the biasing force of the sub return spring 35, the sub poppet valve 27a of the sub valve 27 is seated on the sub seat 26d, and the pilot pressure chamber 42 is in a closed state. Therefore, working oil in the sub port 230 is directed into the pilot pressure chamber 42 via the sub lead-in passage 250, the annular space 40, and the lead-in hole 41, and the pressure inside the pilot pressure chamber 42 becomes equal to the pressure in the sub port 230. That is, the pressure equal to the pressure in the sub port 230 acts on the valve-closing pressure receiving surface S3.

Here, the valve-closing pressure receiving surface S3 on which the pressure inside the pilot pressure chamber 42 acts is larger in area than the second valve-opening pressure receiving surface S2 on which the pressure in the sub port 230 acts. Furthermore, the pressure in the main port 220 is sufficiently lower than the pressure in the sub port 230. Therefore, the net force obtained from the thrust attributed to the pressure inside the pilot pressure chamber 42 acting on the valve-closing pressure receiving surface S3 and from the biasing force of the main return spring 24 exceeds the net force obtained from the thrust attributed to the pressure in the main port 220 acting on the first valve-opening pressure receiving surface S1 and from the thrust attributed to the pressure in the sub port 230 acting on the second valve-opening pressure receiving surface S2. Consequently, the main valve 22 is pushed in the direction of closing the seat 13. Thus, when current is not flowing through the coil 62, the flow of working oil from the sub port 230 to the main port 220 is blocked.

On the other hand, when current is supplied to the coil 62, the thrust generated by the solenoid unit 60 causes the plunger 33 to overcome the biasing force of the sub return spring 35, and the plunger 33 is attracted toward the coil 62. As the sub valve 27 is displaced together with the plunger 33, the sub poppet valve 27a is separated from the sub seat 26d, and a gap is created between the sub poppet valve 27a and the sub seat 26d. Working oil inside the pilot pressure chamber 42 is directed to the first communication passage 23a, that is, the first port P1 of the combination valve 70, via this gap.

As the third port P3 of the combination valve 70 faces the sub port 230, the pressure in the third port P3 is the same as the pressure in the sub port 230. That is, the pressure in the third port P3 is substantially the same as the pressure in the first port P1. Therefore, the first valve body 71 blocks the flow of working oil from the first port P1 to the third port P3 as described above.

On the other hand, as the second port P2 of the combination valve 70 faces the main port 220, the pressure in the second port P2 is sufficiently lower than the pressure in the first port P1, that is, the pressure in the sub port 230. Therefore, the second valve body 72 allows the flow of working oil from the first port P1 to the second port P2 as described above. As a result, working oil inside the pilot pressure chamber 42 is discharged to the main port 220 via the first communication passage 23a and the recess 22g.

As the lead-in hole 41 limits the inflow of working oil from the sub port 230 to the pilot pressure chamber 42, the pressure inside the pilot pressure chamber 42 decreases due to communication between the pilot pressure chamber 42 and the main port 220. The main valve 22 is displaced in the direction of opening the seat 13 until the net force obtained from the thrust attributed to the pressure inside the pilot pressure chamber 42 acting on the valve-closing pressure receiving surface S3 and from the biasing force of the main return spring 24 comes into balance with the net force obtained from the thrust attributed to the pressure in the main port 220 acting on the first valve-opening pressure receiving surface S1 and from the thrust attributed to the pressure in the sub port 230 acting on the second valve-opening pressure receiving surface S2. As a result, working oil flows from the sub port 230 to the main port 220 via the communication holes 12b, the gap between the poppet valve 22b and the second seat portion 13b, and the gap between the through holes 22d and the first seat portion 13a.

An increase in the current supplied to the coil 62 causes the sub poppet valve 27a to be further separated from the sub seat 26d. As a result, an amount of working oil discharged from the pilot pressure chamber 42 to the main port 220 increases, and the pressure inside the pilot pressure chamber 42 further decreases. Along with such a decrease in the pressure inside the pilot pressure chamber 42, the main valve 22 moves further in the direction of opening the seat 13. This leads to an increase in the exposed opening areas of the through holes 22d of the spool valve 22a created by separation from the first seat portion 13a. Consequently, a flow rate of working oil flowing from the sub port 230 to the main port 220 increases.

As described above, a flow rate of working oil flowing from the sub port 230 to the main port 220 is controlled by controlling an amount of displacement of the main valve 22 through an operation of increasing/decreasing current supplied to the coil 62.

When current is stopped from flowing through the coil 62, the thrust that attracts the plunger 33 is dissolved, and thus the plunger 33 is pressed by the biasing force of the sub return spring 35. Then, the sub poppet valve 27a of the sub valve 27 is seated on the sub seat 26d. As a result, working oil in the sub port 230 is directed to the interior of the pilot pressure chamber 42 via the lead-in hole 41, and the pressure inside the pilot pressure chamber 42 increases to the point where it is equal to the pressure in the sub port 230.

Once the pressure inside the pilot pressure chamber 42 has become equal to the pressure in the sub port 230, the net force obtained from the thrust attributed to the pressure in the main port 220 acting on the first valve-opening pressure receiving surface S1 and from the thrust attributed to the pressure in the sub port 230 acting on the second valve-opening pressure receiving surface S2 falls below the net forth obtained from the thrust attributed to the pressure inside the pilot pressure chamber 42 acting on the valve-closing pressure receiving surface S3 and from the biasing force of the main return spring 24, as described above. Thus, the main valve 22 is pushed in the direction of closing the seat 13. As a result, the main valve 22 is displaced in the direction of closing the seat 13, and the flow of working oil from the sub port 230 to the main port 220 is blocked.

As described above, a flow rate of working oil flowing from the main port 220 to the sub port 230 or working oil flowing from the sub port 230 to the main port 220 can be controlled by changing the pressure inside the pilot pressure chamber 42 through an operation of increasing/decreasing current supplied to the coil 62.

When current is not flowing through the coil 62, the pressure inside the pilot pressure chamber 42 increases. When a force exerted by this pressure on the flange 26b exceeds a biasing force of the pressure compensation spring 28, the pressure compensation sleeve 26 is displaced toward the main valve 22. Following the displacement of the pressure compensation sleeve 26, the sub valve 27 and the plunger 33 are also displaced. Accordingly, the sub return spring 35 extends, and its biasing force decreases. Therefore, even if the pressure inside the spring chamber 44 increases along with an increase in the pressure inside the pilot pressure chamber 42, an increase in the thrust required to attracting the plunger 33 is suppressed by a decrease in the biasing force of the sub return spring 35. Thus, the plunger 33 can be always driven by the same current.

The foregoing embodiment achieves the following functions and advantageous effects.

In the present embodiment, the first valve body 71, which restricts a flowing direction of working oil that flows through the second communication passage 23b extending in the radial direction of the main valve 22, is not disposed in the second communication passage 23b, but inside the first communication passage 23a extending in the axial direction of the main valve 22 together with the second valve body 72. As the two valve bodies 71, 72 are thus arranged in series in the first communication passage 23a, the combination valve 70 can be downsized. Furthermore, in the main valve 22 having the combination valve 70 built therein, the radially-extending second communication passage 23b can be shortened because no valve body is disposed therein. Therefore, an outer diameter of the main valve 22 can be made small. This can prevent an increase in the size of the solenoid valve 100, and improve the attachability of the solenoid valve 100.

As there is no need to reduce the first valve body 71 in size, the sealing performance can be maintained over a long period of time compared with a case in which the first valve body 71 has been reduced in size. This leads to improved durability.

As the outer diameter of the main valve 22 is small, an outer diameter of the sleeve 12 can be made small. This can not only reduce the size of the joint member 16 that presses and fixes the sleeve 12, but also reduce the strength of the bolts 15 that fix the joint member 16.

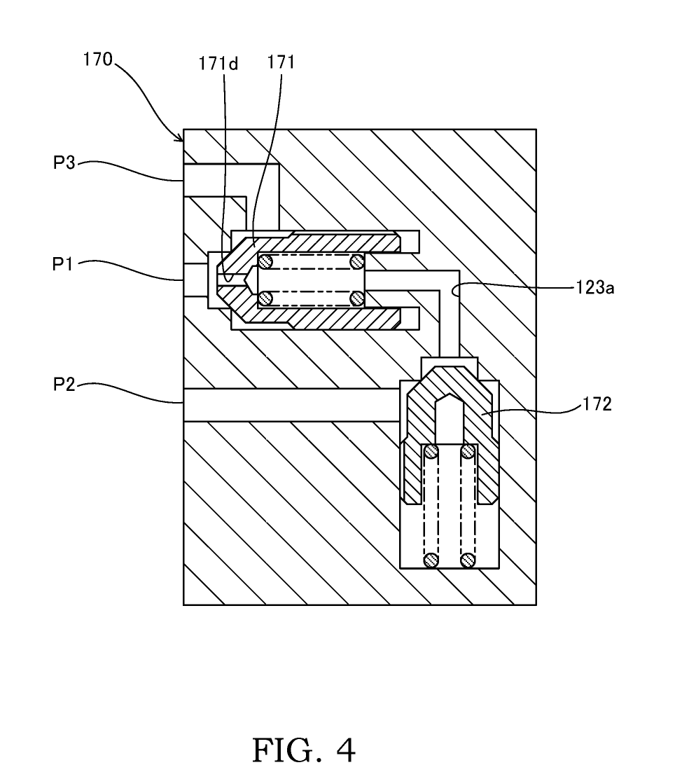

A modification example of the combination valve 70 according to the above-described embodiment will now be described with reference to FIG. 4.

In the combination valve 70 according to the above-described embodiment, the first communication passage 23a, which has the first port P1 and the second port P2, has a linear shape, and a displacement direction of the first valve body 71 is the same as a displacement direction of the second valve body 72. Alternatively, as shown in FIG. 4, a first communication passage 123a may have a bent portion, and a displacement direction of a first valve body 171 may differ from a displacement direction of a second valve body 172.

A combination valve 170 shown in FIG. 4 includes the first valve body 171 that allows only the flow of working oil from the first port P1 to the third port P3, and the second valve body 172 that allows only the flow of working oil from the first port P1 to the second port P2. Similarly to the first valve body 71 of the combination valve 70 according to the above-described embodiment, the first valve body 171 has a through hole 171d via which working oil is directed from the first port P1 to the second valve body 172. The conditions for opening/closing the first valve body 171 and the second valve body 172 are similar to those in the combination valve 70 according to the above-described embodiment, and thus a description thereof will be omitted.

In the modification example shown in FIG. 4, as the first communication passage 123a has the bent portion, the first port P1, the second port P2, and the third port P3 can be configured to open to the same side surface of the combination valve 170. By thus providing the first communication passage 123a with a bent portion or a crank portion bent at a right, acute, or obtuse angle, the combination valve 170 can be downsized, and an opening of each of the ports P1 to P3 can be located at any position.

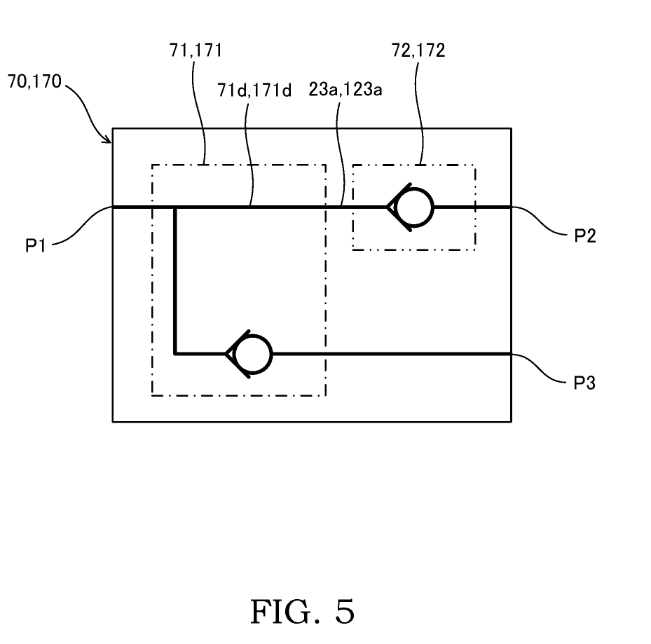

As shown in FIG. 5, the combination valve 70 according to the above-described embodiment and the combination valve 170 according to the modification example have the same hydraulic circuit. In FIG. 5, the first valve body 71 (171) indicated by a one-dot chain line has two functions: a function of directing working oil from the first port P1 to the second valve body 72 (172) that is indicated by a two-dot chain line and located downstream relative to the first valve body 71 (171), and a function of allowing only the flow of working oil from the first port P1 to the third port P3. On the other hand, the second valve body 72 (172) has a function of allowing only the flow of working oil to the second port P2. That is, as long as the first valve body 71 (171) and the second valve body 72 (172) have such functions, the first communication passage 23a (123a) may be routed in any manner. The first communication passage 23a (123a) may be linear as in the above-described embodiment, or may be bent as in the above-described modification example.

The configurations, functions, and advantageous effects of the embodiment of the present invention will be collectively described below.

The combination valve 70 includes: the first communication passage 23a having the first port P1 and the second port P2 located at the upstream side and the downstream side of the first communication passage 23a, respectively; the second communication passage 23b branching from the first communication passage 23a, and having the third port P3; the first valve body 71 provided in the first communication passage 23a, and configured to allow only the flow of working oil from the first port P1 to the third port P3; the through hole 71d provided in the first valve body 71, and being a part of the first communication passage 23a; and the second valve body 72 provided in the first communication passage 23a, and configured to allow only the flow of working oil from the first port P1 to the second port P2 via the through hole 71d. The first valve body 71 is located upstream relative to the second valve body 72.

With this configuration, the first valve body 71, which restricts a flowing direction of working oil flowing through the second communication passage 23b, is not disposed in the second communication passage 23b; the first valve body 71 and the second valve body 72 are arranged in series in the first communication passage 23a. As the two valve bodies 71, 72 are thus arranged in series in one passage, that is, the first communication passage 23a, downsizing can be achieved compared with a case in which the two valve bodies 71, 72 are arranged in separate passages.

The first communication passage 23a has a linear shape.

With this configuration, the first communication passage 23a, in which the first valve body 71 and the second valve body 72 are disposed, has a linear shape. As the two valve bodies 71, 72 are placed in a straight line, downsizing can be achieved and the assembly quality can be improved compared with a case in which the two valve bodies 71, 72 are disposed in a non-linear passage.

The first valve body 71 and the second valve body 72 are displaced along the first communication passage 23a.

With this configuration, the displacement direction of the first valve body 71 and the displacement direction of the second valve body 72 both extend along the first communication passage 23a. As the two valve bodies 71, 72 are displaced in the same direction, downsizing can be achieved compared with a case in which the two valve bodies 71, 72 are displaced in different directions, for example, directions that are perpendicular to each other. Furthermore, as the two valve bodies 71, 72 are displaced in the direction extending along the first communication passage 23a in which they are disposed, downsizing can be achieved compared with a case in which the two valve bodies 71, 72 are displaced in a direction that forms a predetermined angle with respect to the first communication passage 23a.

The combination valve 70 is as follows. When the first port P1 and the second port P2 have substantially the same pressure therein and this pressure is higher than the pressure in the third port P3 by a difference equal to or larger than a predetermined value, the first valve body 71 allows the flow of working oil from the first port P1 to the third port P3, and the second valve body 72 blocks the flow of working oil from the first port P1 to the second port P2. When the first port P1 and the third port P3 have substantially the same pressure therein and this pressure is higher than the pressure in the second port P2 by a difference equal to or larger than a predetermined value, the first valve body 71 blocks the flow of working oil from the first port P1 to the third port P3, and the second valve body 72 allows the flow of working oil from the first port P1 to the second port P2.

With this configuration, whether the first valve body 71 and the second valve body 72 allow or block the flow of working oil differs between when the first port P1 and the second port P2 have substantially the same pressure therein and the pressure in the third port P3 is low compared therewith, and when the first port P1 and the third port P3 have substantially the same pressure therein and the pressure in the second port P2 is low compared therewith. As such, the combination valve 70 can change the flow state of working oil depending on the pressure in each of the ports P1, P2, P3.

The combination valve 70 further includes the support member 76 provided inside the first communication passage 23a. The support member 76 has: the main body 76a fixed inside the first communication passage 23a; the support portion 76b projecting from the main body 76a toward the first port P1, and allowing the first valve body 71 to be slidably supported thereby; the accommodation hole 76c provided inside the main body 76a, and allowing the second valve body 72 to be slidably inserted therein; and the axially penetrating communication hole 76d. Once working oil has passed through the through hole 71d provided in the first valve body 71, it is directed to the second valve body 72 via the communication hole 76d.

With this configuration, the first valve body 71 and the second valve body 72 are supported by one support member 76 provided inside the first communication passage 23a. Thus, with the use of a single support member 76, the two valve bodies 71, 72 can easily be disposed inside the first communication passage 23a. Furthermore, with this configuration, the first valve body 71 and the second valve body 72 do not have their respective support members and housings. Accordingly, the manufacturing cost can be reduced.

The combination valve 70 further includes: the first spring 73 interposed between the first valve body 71 and the support portion 76b, and configured to bias the first valve body 71 in the direction of closing the first valve body 71; and the second spring 74 disposed inside the accommodation hole 76c, and configured to bias the second valve body 72 in the direction of closing the second valve body 72. A biasing direction of the first spring 73 and a biasing direction of the second spring 74 both extend along the first communication passage 23a.

With this configuration, the direction in which the first valve body 71 is biased and the direction in which the second valve body 72 is biased both extend along the first communication passage 23a. As the two valve bodies 71, 72 are biased in the same direction, downsizing can be achieved compared with a case in which the two valve bodies 71, 72 are biased in different directions, for example, directions that are perpendicular to each other. Furthermore, as the two valve bodies 71, 72 are biased in the direction extending along the first communication passage 23a in which they are disposed, downsizing can be achieved compared with a case in which the two valve bodies 71, 72 are biased in a direction that forms a predetermined angle with respect to the first communication passage 23a.

The first valve body 71 has: the hollow cylindrical portion 71a extending along the first communication passage 23a, and allowing the support portion 76b to be inserted therein; and the top end portion 71b provided with the through hole 71d and the valve portion 71c configured to be seated on the seat 23d provided in the first communication passage 23a. The support portion 76b of the support member 76 defines the first pressure chamber 79 inside the first valve body 71, and the pressure in the first port P1 is directed to the first pressure chamber 79 via the through hole 71d. When the valve portion 71c is seated on the seat 23d, the first pressure receiving surface A1 of the top end portion 71b is larger in area than the second pressure receiving surface A2 of the top end portion 71b, the first pressure receiving surface A1 receiving the pressure in the first port P1 acting in the direction of opening the first valve body 71, the second pressure receiving surface A2 receiving the pressure in the first pressure chamber 79.

As the pressure in the first port P1 acts on the first pressure receiving surface A1 and the second pressure receiving surface A2, the first valve body 71 cannot be opened if the second pressure receiving surface A2 is larger in area than the first pressure receiving surface A1. With the foregoing configuration, the first pressure receiving surface A1 of the top end portion 71b that receives the pressure in the first port P1 acting in the direction of opening the first valve body 71 is larger in area than the second pressure receiving surface A2 of the top end portion 71b that receives the pressure in the first pressure chamber 79. Therefore, the first valve body 71 can be opened reliably.

The first valve body 71 has: the hollow cylindrical portion 71a extending along the first communication passage 23a, and allowing the support portion 76b to be inserted therein; and the top end portion 71b provided with the through hole 71d and the valve portion 71c configured to be seated on the seat 23d provided in the first communication passage 23a. The second pressure chamber 80 is provided between the first valve body 71 and the main body 76a of the support member 76, and the pressure in the third port P3 is directed to the second pressure chamber 80 via the communication passage 80a to bias the first valve body 71 in the direction of closing the first valve body 71. The communication passage 80a is provided in the first valve body 71 or the first communication passage 23a.

With this configuration, the second pressure chamber 80, to which the pressure in the third port P3 is directed, is provided between the first valve body 71 and the main body 76a of the support member 76. Therefore, when the third port P3 and the first port P1 have substantially the same pressure therein, a force that biases the first valve body 71 in the direction of closing the first valve body 71 becomes large, making it possible to reliably close the first valve body 71 and preventing a reverse flow from the third port P3 to the first port P1. On the other hand, when the pressure in the third port P3 is low, the force that biases the first valve body 71 in the direction of closing the first valve body 71 becomes small, making it possible to reliably open the first valve body 71.

The first valve body 71 also has the hollow cylindrical portion 71a that extends along the first communication passage 23a and allows the support portion 76b to be inserted therein, and the top end portion 71b provided with the through hole 71d and the valve portion 71c that can be seated on the seat 23d provided in the first communication passage 23a. The O-ring 81 compressed between the support portion 76b and the hollow cylindrical portion 71a is mounted on the outer circumference of the support portion 76b.

With this configuration, the O-ring 81 compressed between the support portion 76b and the hollow cylindrical portion 71a is provided. Therefore, working oil directed from the first port P1 to the interior of the hollow cylindrical portion 71a via the through hole 71d can be prevented from leaking to the third port P3 via a gap between the support portion 76b and the hollow cylindrical portion 71a. Furthermore, working oil in the third port P3 can be prevented from entering the interior of the hollow cylindrical portion 71a via the gap between the support portion 76b and the hollow cylindrical portion 71a.

The seat 23d that forms a circular truncated cone is provided in the first communication passage 23a. The first valve body 71 is a poppet valve that can be seated on the seat 23d.

With this configuration, the first valve body 71 is configured as a poppet valve that can be seated on the seat 23d provided in the first communication passage 23a. Therefore, when the first valve body 71 is seated on the seat 23d, the flow of working oil from the first port P1 to the third port P3 can be blocked reliably.

The solenoid valve 100 is a bidirectional flow control valve for controlling a flow rate of a working fluid flowing from the main port 220 to the sub port 230 and a flow rate of the working fluid flowing from the sub port 230 to the main port 220, and includes: the main valve 22 having the above-described combination valve 70 built therein, and configured to change an opening degree for communication between the main port 220 and the sub port 230; the pilot pressure chamber 42 allowing working oil to be directed thereto from the main port 220 or the sub port 230, and configured to bias the main valve 22 in the direction of closing the main valve 22; and the solenoid unit 60 configured to control the pressure in the pilot pressure chamber 42. The combination valve 70 is disposed inside the main valve 22 in such a manner that the first port P1 is connected to the pilot pressure chamber 42 via the solenoid unit, the second port P2 communicates with the main port 220, and the third port P3 communicates with the sub port 230.

With this configuration, the combination valve 70 is disposed inside the main valve 22 in such a manner that the first port P1 is connected to the pilot pressure chamber 42, the second port P2 communicates with the main port 220, and the third port P3 communicates with the sub port 230. As the downsized combination valve 70 is thus disposed inside the main valve 22, the outer diameter of the main valve 22 can be made small. This can prevent an increase in the size of the solenoid valve 100, and improve the attachability of the solenoid valve 100.

The first communication passage 23a is provided in the main valve 22 in such a manner that the central axis of the first communication passage 23a coincides with the central axis of the main valve 22.

With this configuration, the central axis of the first communication passage 23a coincides with the central axis of the main valve 22. Therefore, the first communication passage 23a can be processed along with processing of the recess 22g of the main valve 22 and the like. This can improve the precision of processing of the first communication passage 23a, and reduce the processing cost. Furthermore, as no valve body is disposed in the second communication passage 23b that extends radially from the first communication passage 23a, the second communication passage 23b can be shortened compared with a case in which a valve body is disposed in the second communication passage 23b. Therefore, the outer diameter of the main valve 22 can be made small.

Embodiments of the present invention were described above, but the above embodiments are merely examples of applications of the present invention, and the technical scope of the present invention is not limited to the specific constitutions of the above embodiments.

For example, although the combination valve 70 is used in the solenoid valve 100 in the foregoing embodiment, it is not limited to being used in the solenoid valve 100, and may be used in any device that needs to control the flow of a working fluid between three ports.

Although the second valve body 72 of the combination valve 70 is described as a check valve in the foregoing embodiment, it is not limited to being a check valve, and may be a valve body of any form as long as it is configured to allow the flow of a working fluid from the first port P1 to the second port P2 as with a relief valve, for example.

This application claims priority based on Japanese Patent Application No. 2015-152406 filed with the Japan Patent Office on Jul. 31, 2015, the entire contents of which are incorporated into this specification.

1. A combination valve, comprising:
a first flow passage having a first port and a second port located at an upstream side and a downstream side of the first flow passage, respectively;
a second flow passage branching from the first flow passage and having a third port;
a first valve body provided in the first flow passage and configured to allow only a flow of a working fluid from the first port to the third port;
a through hole provided in the first valve body and forming a part of the first flow passage; and
a second valve body provided in the first flow passage and configured to allow only the flow of the working fluid from the first port to the second port via the through hole,
wherein the first valve body is located upstream relative to the second valve body.

2. The combination valve according to claim 1,
wherein
the first valve body allows the flow of the working fluid from the first port to the third port when a pressure in the first port is higher than a pressure in the third port by a difference equal to or larger than a predetermined value, and
the second valve body allows the flow of the working fluid from the first port to the second port when the pressure in the first port is higher than a pressure in the second port by a difference equal to or larger than a predetermined value.

3. The combination valve according to claim 1, further comprising
a support member provided inside the first flow passage,
wherein
the support member has
a main body fixed inside the first flow passage,
a support portion projecting from the main body toward the first port and configured to slidably support the first valve body,
a accommodation hole provided inside the main body and configured to allow the second valve body to be slidably inserted therein, and
an axially penetrating communication hole, and
once the working fluid has passed through the through hole provided in the first valve body, the working fluid is directed to the second valve body via the communication hole.

4. The combination valve according to claim 3, further comprising:
a first biasing member interposed between the first valve body and the support portion and configured to bias the first valve body in a direction of closing the first valve body; and
a second biasing member disposed inside the accommodation hole, and configured to bias the second valve body in a direction of closing the second valve body,
wherein a biasing direction of the first biasing member and a biasing direction of the second biasing member both extend along the first flow passage.

5. The combination valve according to claim 3,
wherein
the first valve body has
a hollow cylindrical portion extending along the first flow passage and configured to allow the support portion to be inserted therein, and
an top end portion provided with the through hole and a valve portion configured to be seated on a seat provided in the first flow passage,
the support portion of the support member defines a first pressure chamber inside the first valve body, the first pressure chamber being configured such that a pressure in the first port is directed to the first pressure chamber via the through hole, and
when the valve portion is seated on the seat, a first pressure receiving surface of the top end portion has larger area than that of a second pressure receiving surface of the top end portion, the first pressure receiving surface being configured to receive the pressure in the first port acting in a direction of opening the first valve body, the second pressure receiving surface being configured to receive a pressure in the first pressure chamber.

6. The combination valve according to claim 3,
wherein
the first valve body has
a hollow cylindrical portion extending along the first flow passage and configured to allow the support portion to be inserted therein, and
an top end portion provided with the through hole and a valve portion configured to be seated on a seat provided in the first flow passage,
a second pressure chamber is provided between the first valve body and the main body of the support member, and a pressure in the third port being directed to the second pressure chamber via a communication passage to bias the first valve body in a direction of closing the first valve body, and
the communication passage is provided in the first valve body or the first flow passage.

7. The combination valve according to claim 1,
wherein the first flow passage has a linear shape.

8. The combination valve according to claim 1,
wherein the first valve body and the second valve body are displaced along the first flow passage.

9. A bidirectional flow control valve for controlling a flow rate of a working fluid flowing from a main port to a sub port and the flow rate of the working fluid flowing from the sub port to the main port, the bidirectional flow control valve comprising:
a main valve having the combination valve according to claim 1 built therein and configured to change an opening degree for communication between the main port and the sub port;
a control pressure chamber configured to allow the working fluid to be directed thereto from the main port or the sub port and configured to bias the main valve in a direction of closing the main valve; and
a solenoid unit configured to control a pressure in the control pressure chamber,
wherein the combination valve is disposed inside the main valve in such a manner that the first port is connected to the control pressure chamber via the solenoid unit, the second port communicates with the main port, and the third port communicates with the sub port.

10. The bidirectional flow control valve according to claim 9,
wherein the first flow passage of the combination valve is provided in the main valve in such a manner that a central axis of the first flow passage coincides with a central axis of the main valve.
